(19) United States
(12) Patent Application Publication
(10) Pub. No.: US 2011/0010403 A1
(43) Pub. Date: Jan. 13, 2011

(54) ELECTRONIC FILE CONVERSION APPARATUS, ELECTRONIC FILE CONVERTING METHOD AND COMPUTER READABLE MEDIUM

(75) Inventor: Toshiyuki KOMADA, Kanagawa (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/726,901

(22) Filed: Mar. 18, 2010

(30) Foreign Application Priority Data
Jul. 10, 2009 (JP) 2009-163772

(51) Int. Cl. G06F 17/30

(52) U.S. Cl. 707/822; 707/E17.01

(57) ABSTRACT

An electronic file conversion apparatus includes a first management unit, a first changing unit, a conversion unit, a transfer unit and a second management unit. The first management unit receives a first electronic file, and associates the first electronic file with an identifier. The first changing unit changes a file name of the first electronic file by adding the identifier. The conversion unit converts the first electronic file into a second electronic file based on drawing information of the first electronic file generated by an operating system. The transfer unit transfers the changed file name of the first electronic file to a file name of the second electronic file. The second management unit associates the first electronic file with the second electronic file based on the identifier included in the changed file name of the first electronic file and the file name of the second electronic file.

### CROSS-REFERENCE TO RELATED APPLICATION

This application is based on and claims priority under 35 USC119 from Japanese Patent Application No. 2009-163722 filed on Jul. 10, 2009.

### BACKGROUND

### 1. Technical Field

The present invention relates to an electronic file conversion apparatus, an electronic file converting method and a computer readable medium.

### SUMMARY

According to an aspect of the invention, an electronic file conversion apparatus that converts an electronic file using an operating system, includes a first management unit, a first changing unit, a conversion unit, a transfer unit and a second management unit. The first management unit receives a first electronic file, and associates the first electronic file with an identifier. The first changing unit changes a file name of the first electronic file by adding the identifier. The conversion unit converts the first electronic file with the changed file name into a second electronic file based on drawing information of the first electronic file generated by the operating system. The transfer unit transfers the changed file name of the first electronic file to a file name of the second electronic file. The second management unit associates the first electronic file with the second electronic file based on the identifier included in the changed file name of the first electronic file and the file name of the second electronic file.

### BRIEF DESCRIPTION OF THE DRAWINGS

Exemplary embodiments of the invention will be described in detail based on the following figures, wherein:

FIG. 1 is a diagram schematically illustrating an example of the structure of an electronic file conversion system according to a first embodiment of the invention;

FIG. 2 is a diagram schematically illustrating an example of the structure of an electronic file conversion server according to the first embodiment of the invention;

FIG. 3 is a diagram schematically illustrating an example of the conversion of an electronic file according to the first embodiment of the invention;

FIG. 4 is a flowchart illustrating an example of the operation of the electronic file conversion system according to the first embodiment of the invention; and

FIG. 5 is a diagram schematically illustrating an example of the conversion of an electronic file according to a second embodiment of the invention.

### DETAILED DESCRIPTION

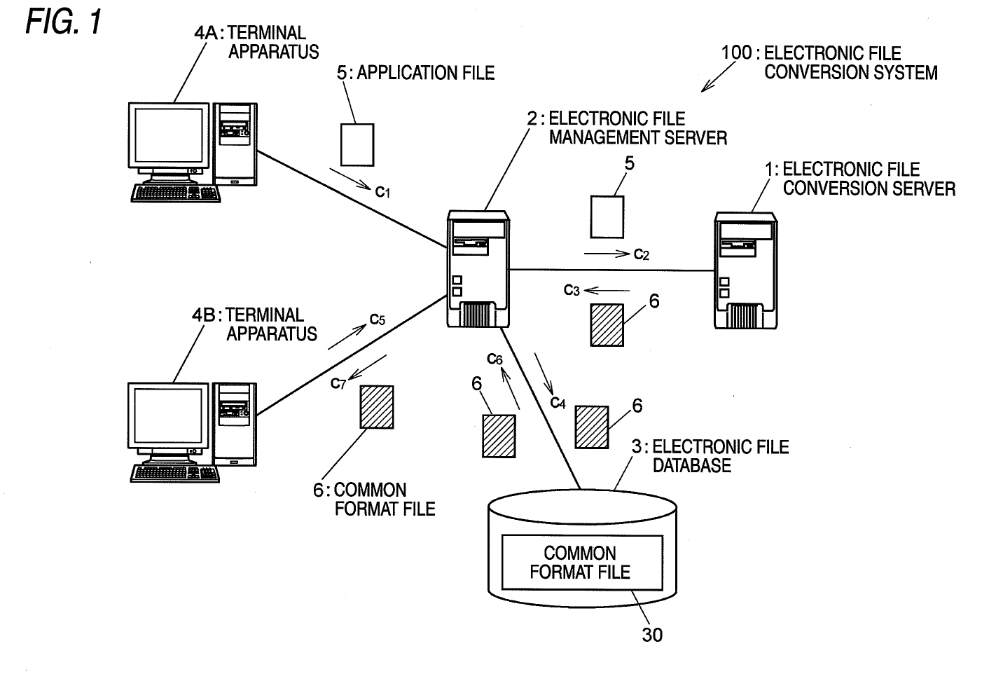

FIG. 1 is a diagram schematically illustrating an example of the structure of an electronic file conversion system according to a first embodiment of the invention.

An electronic file conversion system 100 includes: an electronic file conversion server 1 that receives an application file 5 generated by an application, such as a word processor, a table calculating application, or a drawing application, as an electronic file and converts the electronic file, such as a PDF (Portable Document Format) file or a DocuWorks (registered trademark) file into a common format file 6; an electronic file management server 2 that manages the communication of the electronic file among the electronic file conversion server 1, an electronic file database, and terminal apparatuses 4A and 4B; and the terminal apparatuses 4A and 4B that generate the application file 5 and refer to a common format file 30 of the electronic file database 3.

The electronic file management server 2 receives the application file 5 generated by the terminal apparatus 4A or 4B (C1). Then, the application file 5 is transmitted from the electronic file management server 2 to the electronic file conversion server 1 (C2), and the common format file 6 converted by the electronic file conversion server 1 is stored in the electronic file database 3 (C4) through the electronic file management server 2 (C3). The electronic file conversion server 1 and the electronic file management server 2 may be integrated into one apparatus.

When the terminal apparatus 4A or 4B requests the electronic file management server 2 to refer to the electronic file (C5), the electronic file management server 2 acquires the common format file 6 from the electronic file database 3 (C6) and transmits the acquired common format file 6 to the terminal apparatus 4A or 4B (C7).

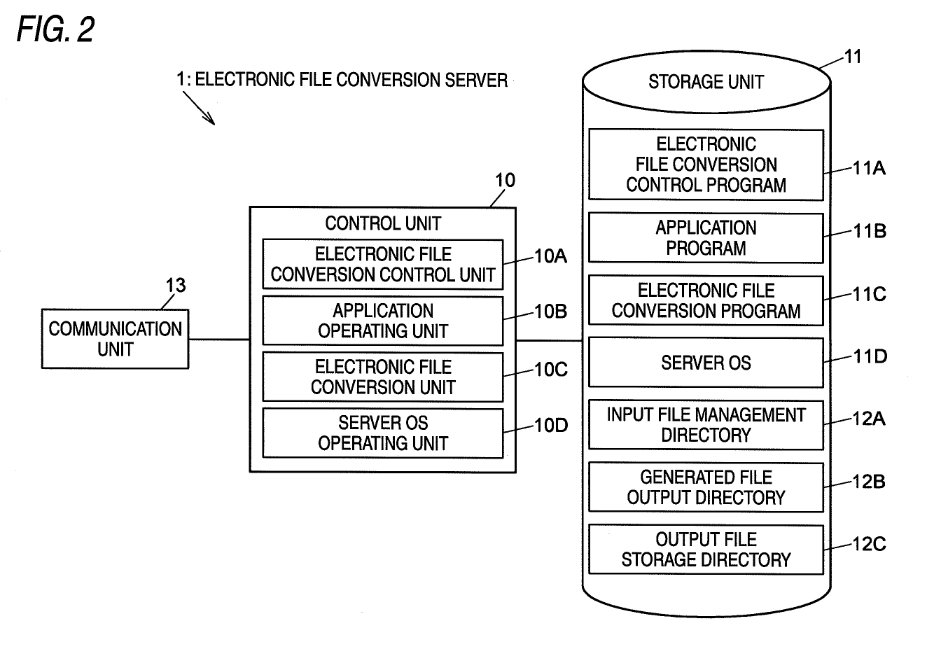

FIG. 2 is a diagram schematically illustrating an example of the structure of the electronic file conversion server according to the first embodiment of the invention.

The electronic file conversion server 1 includes: a control unit 10 that includes, for example, a CPU (Central Processing Unit) and a memory, controls each unit, and executes various kinds of programs; a storage unit 11 that includes a storage device, such as an HDD (Hard Disk Drive) or a flash memory, and stores information; and a communication unit 13 that communicates with the electronic file management server 2 through a network, such as a LAN (Local Area Network).

The control unit 10 executes an electronic file conversion program 11A, which will be described below, to operate an electronic file conversion control unit 10A. In addition, the control unit 10 executes an operating system 11D (server OS) of the server and an application program 11B, which will be described below, to operate an application operating unit 10B, and executes an electronic file conversion program 11C, which will be described below, to operate an electronic file conversion unit 10C.

The electronic file conversion control unit 10A receives the application file 5 from the electronic file management server 2, associates the received file with the common format file 6 generated by the electronic file conversion unit 10C, which will be described below, and outputs the file. In addition, the electronic file conversion control unit 10A changes the file names of the application file 5 and the common format file 6, if necessary. The electronic file conversion control unit 10A allocates an ID that is uniquely determined to the received application file 5.

The application operating unit 10B opens the application file 5 and executes a drawing program of a server OS operating unit 10D to generate drawing data from the application file 5. The drawing data is also called print data that is used for printing. When the operating system is Windows (registered trademark), data is generated as an EMF (Enhanced Metafile). When the operating system is the Macintosh (registered trademark) OS, data is generated as QuickDraw.

The electronic file conversion unit 10C uses the print data to generate data, such as a PDF file or a DocuWorks file, as the common format file. In general, the application, such as a word processor, a table calculating application, or a drawing application, includes a command to print the generated application file. When a print command is issued, print data is generated according to the drawing program of the operating system. The application or the operating system controls the generation of the print data. The print data can be associated with the application file in process order. When a plurality of applications generates the print data in parallel, the times when the print data is generated are different from each other and the completion of the generation of the print data and the process order are also considered. Therefore, the association between the print data is not necessarily correct. In this embodiment, the common format file is generated on the basis of the print command of the application and print data generated by the print command, and the conversion of the electronic file using the file name is controlled while the common format file is generated.

The storage unit 11 stores the electronic file conversion control program 11A that allows the control unit 10 to function as the above-mentioned units, an application program 11B that allows the control unit 10 to function as the application operating unit 10B, an electronic file conversion control program 11C that allows the control unit 10 to function as the electronic file conversion unit 10C, and a server operating system (OS) 11D that allows the control unit to function as the server OS operating unit 10D that controls the overall operation of the electronic file conversion server 1.

In addition, the storage unit 11 stores an input file management directory 12A into which the application file 5 received from the electronic file management server 2 is stored, a generated file output directory 12B into which the common format file generated by the electronic file conversion unit 10C is stored, and an output file storage directory 12C into which the common format file 6 that has been completely associated with the application file 5 and is to be output to the electronic file management server 2 is stored.

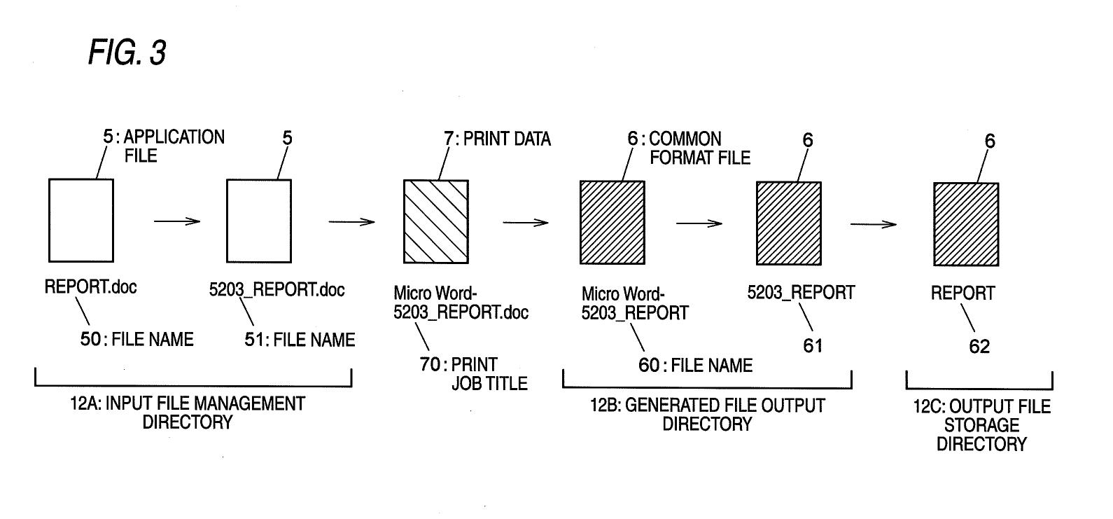

FIG. 3 is a diagram schematically illustrating an example of the conversion of the electronic file according to the first embodiment of the invention.

When the application file 5 with a file name 50 is transmitted to the electronic file conversion server 1, the application file 5 is stored in the input file management directory 12A. Then, the electronic file conversion control unit 10A allocates, for example, an ID ‘5203’ to the application file 5, and the file name of the application file 5 is changed to a file name 51 corresponding to the ID ‘5203’.

Print data 7 is generated from the application file 5 by the operation of the application operating unit 10B according to the drawing program of the server OS operating unit 10D. The print data 7 has a print job title 70 being changed by adding an application name ‘MicroWord’ to the file name 51. The application is given depending on the specifications of the application program 11B.

The common format file 6 is generated from the print data 7 by the electronic file conversion unit 10C, has a file name 60 transferred from the name of the print job title 70, and is stored in the generated file output directory 12B. Then, when there is an application file name in the file name 60, the application file name is removed from the file name 60 of the common format file 6 and the common format file 6 has a file name 61 including an ID and the original file name 50.

Then, the common format file 6 is associated with the original application file 5 based on the ID, has a file name 62 being changed by removing the ID from the file name 61, and is stored in the output file storage directory 12C. When the electronic file is converted into the common format file, the electronic file conversion control unit 10A uses the allocated ID for the association of the electronic file before and after format conversion through the file name of the electronic file.

Next, the operation of an electronic file conversion system according to an embodiment of the invention will be described with reference to the drawings.

First, for example, the user uses an arbitrary application of the terminal apparatus 4A to generate the application file 5 and requests the electronic file management server 2 to register the generated application file 5. The electronic file management server 2 transmits the application file 5 to the electronic file conversion server 1 in response to the registration request. The electronic file conversion server 1 converts the application file 5 into the common format file 6 such that the terminal apparatus in which the application generating the application file 5 is not installed but an application capable of analyzing the common format file is installed can display, read, and print the common format file.

Next, the content of the operation of the electronic file conversion server 1 receiving the application file 5 and converting the application file 5 into the common format file 6 will be described.

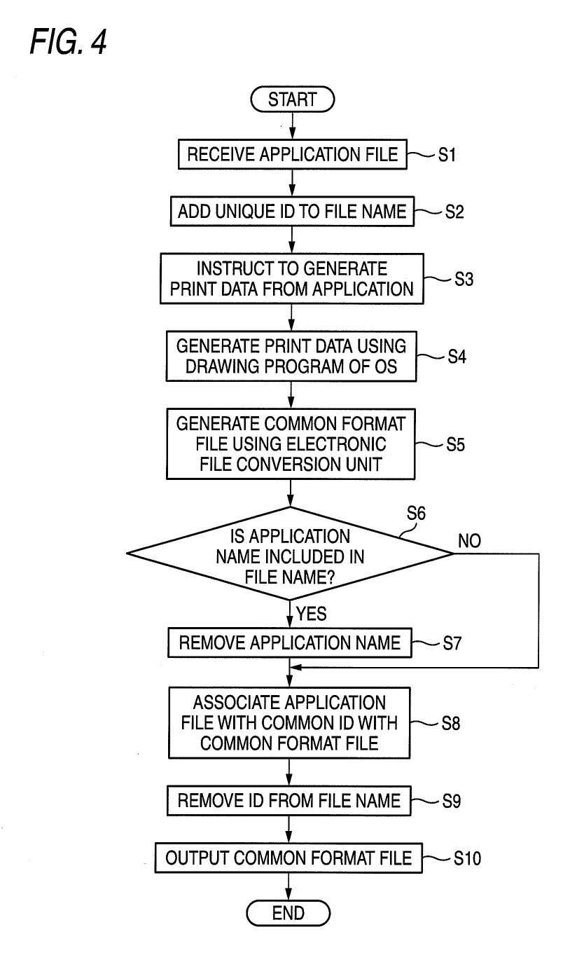

FIG. 4 is a flowchart illustrating an example of the operation of the electronic file conversion system according to the first embodiment of the invention.

First, the electronic file conversion control unit 10A receives the application file 5 from the electronic file management server 2 and stores the application file 5 in the input file management directory 12A (S1). Then, the electronic file conversion control unit 10A allocates a unique ID to the received application file and changes the file name 50 of the application file 5 into the file name 51 having the ID added thereto, as shown in FIG. 3 (S2).

Then, the application operating unit 10B opens the application file 5, executes a print command (S3), and generates the print data 7 with the print job title 70 using the drawing program of the server OS operating unit 10D (S4). The electronic file conversion unit 10C generates the common format file 6 from the print data 7 and stores the common format file 6 in the generated file output directory 12B (S5).

Then, the electronic file conversion control unit 10A checks the file name 60 of the generated common format file 6. When the application name is included in the file name (S6; Yes), the electronic file name changing unit 10B removes the application name (S7). When the application name is not included in the file name (S6; No), Step S7 is omitted.

Then, the electronic file conversion control unit 10A compares the file name 50 with the file name 61 and associates the application file 5 with the common format file 6 (S8). The electronic file conversion control unit 10A removes the ID from the file name 61 of the common format file 6 to generate a file name 62 (S9), and stores the common foi mat file 6 in the output file storage directory 12C.

Then, the electronic file conversion control unit 10A outputs the common format file 6 stored in the output file storage directory 12C to the electronic file management server 2 (S10).

In a second embodiment, a plurality of terminals that receives application files at the same time is provided, and the application file is associated with the common format file in the terminals.

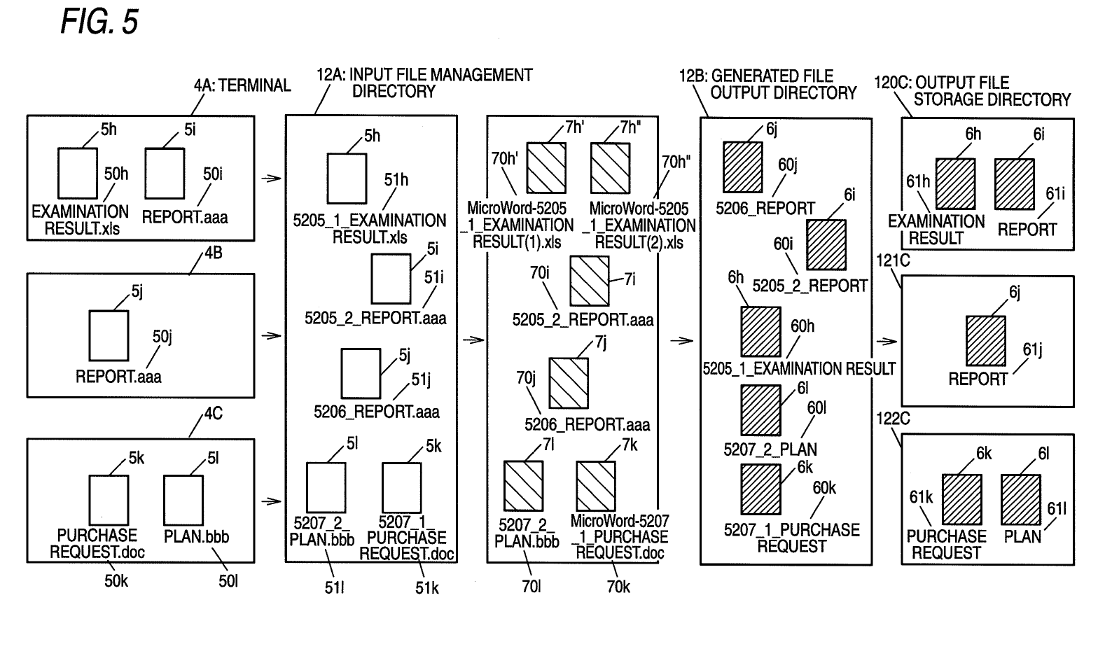

FIG. 5 is a diagram schematically illustrating an example of the conversion of an electronic file according to the second embodiment of the invention.

Application files 5h to 5l having file names 50h to 50l are transmitted from terminals 4A to 4C to the electronic file conversion server through the electronic file management server 2 and are stored in the input file management directory 12A by the electronic file conversion control unit 10A. The electronic file conversion control unit 10A gives IDs, which are set to each terminal and each application file, to the application files 5h to 5l. For example, four digits ‘5205’ to ‘5207’ are given to the terminals and one digit ‘1’ and ‘2’ is given to each file. Therefore, the electronic file conversion control unit 10A gives combinations of the digits to the file names 50h to 50l to change the file names 50h to 50l into file names 51h to 51l. The electronic file conversion control unit 10A manages the order in which the application files 5h to 5l are stored in the input file management directory 12A. The order may be different from the order in which the application files 5h to 5l are received from the terminals 4A to 4C. Different IDs may be applied to the application files, and the allocated IDs may be associated with the IP addresses of the terminals. In this way, the receivers of the application files may be managed.

Print data 7h′ to 7l is generated from the application files 5h to 5l by the application operating unit 10B and the drawing program of the server OS operating unit 10D. An application name, for example, ‘MicroExcel’ or ‘MicroWord’ may be given to the file name, as in print job titles 70h′, 70″, and 70k. The print data 7h′ and 7h″ is generated from the application file 5h and is divided into two pieces of print data in terms of the structure of data. The print data 7h′ to 7l is generated in parallel by each application.

Common format files 6h to 6l are generated from the print data 7h′ to 7l by the electronic file conversion unit 10C, have file names 60h to 60l transferred from the file names of the print job titles 70h′ to 70l, respectively, and are stored in the generated file output directory 12B. The electronic file conversion unit 10C processes all of the print data 7h′ to 7l in parallel to generate the common format files 6h to 6l. The order in which the common format files 6h to 6l are generated and output is not necessarily identical to the order in which the electronic file conversion unit 10C receives the common format files 6h to 6l. The file names 60h to 60l include the original file names 50h to 50l and IDs from which the application names are removed, respectively.

Then, the electronic file conversion control unit 10A associates the common format files 6h to 6l with the original application files 5h to 5l on the basis of the IDs. The common format files 6h to 6l have file names 61h to 61l from which the IDs are removed and are stored in output file storage directories 120C to 121C that are generated in the terminals 4A to 4C, respectively.

The invention is not limited to the above-described embodiments, but various modifications and changes of the invention can be made without departing from the scope and spirit of the invention. For example, the functions of the application operating unit 10B and the electronic file conversion unit 10C may be implemented by the electronic file conversion control program 11A.

The electronic file conversion control unit 10A, the application operating unit 10B, and the electronic file conversion unit 10C according to the above-described embodiments may be read from a storage medium, such as a CD-ROM, to the storage unit of the apparatus, or they may be downloaded from a server that is connected to the network, such as the Internet, to the storage unit of the apparatus. In addition, some or all of the units according to the above-described embodiments may be implemented by hardware, such as ASIC.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electronic file conversion apparatus that converts an electronic file using an operating system, comprising:
a first management unit that receives a first electronic file, and that associates the first electronic file with an identifier;
a first changing unit that changes a file name of the first electronic file by adding the identifier;
a conversion unit that converts the first electronic file with the changed file name into a second electronic file based on drawing information of the first electronic file generated by the operating system;
a transfer unit that transfers the changed file name of the first electronic file to a file name of the second electronic file; and
a second management unit that associates the first electronic file with the second electronic file based on the identifier included in the changed file name of the first electronic file and the file name of the second electronic file.

2. The electronic file conversion apparatus according to claim 1, further comprising:
a second changing unit that changes the file name of the second electronic file by removing the identifier from the file name of the second electronic file after the second management unit associates the first electronic file with the second electronic file.

3. An electronic file converting method that converts an electronic file using an operating system, comprising:
receiving a first electronic file;
associating the first electronic file with an identifier;
changing a file name of the first electronic file by adding the identifier;
converting the first electronic file with the changed file name into a second electronic file based on drawing information of the first electronic file generated by the operating system;
transferring the changed file name of the first electronic file to a file name of the second electronic file; and
associating the first electronic file with the second electronic file based on the identifier included in the changed file name of the first electronic file and the file name of the second electronic file.

4. The electronic file converting method according to claim 3, further comprising:
changing the file name of the second electronic file by removing the identifier from the file name of the second electronic file after associating the first electronic file with the second electronic file.

5. A computer readable medium storing a program causing a computer to execute a process for converting an electronic file using an operating system, the process comprising:
receiving a first electronic file;
associating the first electronic file with an identifier;
changing a file name of the first electronic file by adding the identifier;
converting the first electronic file with the changed file name into a second electronic file based on drawing information of the first electronic file generated by the operating system;
transferring the changed file name of the first electronic file to a file name of the second electronic file; and
associating the first electronic file with the second electronic file based on the identifier included in the changed file name of the first electronic file and the file name of the second electronic file.

6. The computer readable medium according to claim 5, the process further comprising:
changing the file name of the second electronic file by removing the identifier from the file name of the second electronic file after associating the first electronic file with the second electronic file.
